(19) United States
(12) Patent Application Publication
(10) Pub. No.: US 2017/0132721 A1
(43) Pub. Date: May 11, 2017

(54) Data Processing System and Method for Financial or Non-Financial Data

(71) Applicant: Cronus Consulting Group Pty Ltd, Sydney, NSW (AU)

(72) Inventor: Steven Riley, Sydney, NSW (AU)

(21) Appl. No.: 15/321,768

(22) PCT Filed: Jun. 30, 2015
(86) PCT No.: PCT/AU2015/050366

§ 371 Date: Dec. 23, 2016

(30) Foreign Application Priority Data
Jun. 30, 2014 (AU) 2014902515

(51) Int. Cl. G06Q 40/00; G06F 17/30

(52) U.S. Cl. CPC G06Q 40/128; G06F 17/30477; G06F 17/30371

(57) ABSTRACT

A data processing system and method for producing a report from an organizationally related set of discrete data sourced from a plurality of financial or non-financial systems of an organization, or a combination of both, each compiled to comply with the same or a different set of business requirements or practices to the other. A data input means receives raw data in relation to various business units of the organization sourced from the financial or nonfinancial systems of the organization to which the data relates. A first stage mapping means maps the raw data into a first database structure using a primary data dictionary. A second stage mapping means further maps the first stage mapped data into a second database structure using a secondary data dictionary detailing the second stage mapped data.

### FIELD OF THE INVENTION

This invention relates to a data processing system and method for generating a related set of discrete data sourced from a plurality of financial or non-financial systems, or a combination of both, where the financial and non-financial systems are each compiled to comply with the same or a different set of requirements to the other.

The invention has particular, but not exclusive, utility for a multinational organisation having different segments engaging in different activities, where each segment compiles data in financial and/or non-financial systems to comply with the same or different financial or non-financial requirements, respectively to each other. In this type of scenario it can be particularly desirous to obtain a uniform report that normalises the data for the purposes of comparison across the various segments or to analyse that data.

Throughout this specification, the use of the term “related” with respect to a set of discrete data is intended to denote that the data when grouped across all of the financial and non-financial systems, is of relevance to a viewer of the collected group of data, even though the data at a discrete level is unrelated to each other.

Furthermore, the use of the term “unrelated” with respect to financial and non-financial systems is intended to denote that each financial or non-financial system is independent of other financial or non-financial systems, and may or may not be the same as the other financial or non-financial systems of the other.

This independence may be brought about by the necessity to comply with a different practice. For example, with respect to unrelated financial systems, a subsidiary company of a multinational group of companies in Germany may be required to compile and report its financial data to comply with the International Financial Reporting Standard (IFRS) in Euro, and a subsidiary company of the group in USA may be required to compile and report its financial data to comply with the Generally Accepted Accounting Principles (GAAP) in USA in USD.

Another, example may be a large state based entity having numerous divisions, each compiling and reporting data according to its own arbitrary set of rules established by the segment manager to satisfy the segment's needs using financial and non-financial systems that are local to that segment, without any regard to another segment, whose manager compiles and reports data according to his or her own set of rules to satisfy that segments needs using different financial and non-financial systems local to that division.

Throughout the specification, unless the context requires otherwise:

the word “comprise” or variations such as “comprises” or “comprising”, will be understood to imply the inclusion of a stated integer or group of integers but not the exclusion of any other integer or group of integers; and the term “business unit” will be understood to mean an organization or organizational subset that is independent with regard to one or more accounting or operational functions being derived from either the financial or non-financial systems of an organization.

### BACKGROUND ART

The following discussion of the background art is intended to facilitate an understanding of the present invention only. It should be appreciated that the discussion is not an acknowledgement or admission that any of the material referred to was part of the common general knowledge as at the priority date of the application.

With the increasing globalization of the world economy, there are innumerable organizations conducting different activities in regions that adopt different financial and non-financial systems. Sometimes this is brought about by necessity, such as where compliance with a particular financial or accounting standard is required. An example may be where compliance with IFRS is required in one region, and compliance with a particular GAAP standard is required in another region, or where one currency is required to be used in one country, and another currency is required to be used in another.

These different financial and non-financial systems may not be limited to a regional problem arising from globalization and may be brought about by legacy issues arising from new product development and the need for backward compatibility. It may also arise where there is a lack of harmonization in using different formats for management accounts across different segments of the business and the use of different systems. For example, an organization may have a real estate segment and a building construction segment, which require different reporting formats.

In the case of non-financial systems, it may arise where one subsidiary company or segment was using one payroll system, and another company or segment was using another payroll system.

Furthermore it may arise where the one subsidiary or division adopts an ERP system for business management and produces management accounts, but is required to also provide a set of statutory accounts.

Consequently, along with this corporate globalization or simply as a result of organizational growth, there has been a recognition of the imperative to harmonize and standardize these reporting requirements and systems for the benefit of these organizations.

This has created an interesting dilemma in countries and regions attempting to maintain their independence in determining their own legal and accounting standards that apply in their country and region as their sovereign right to do so having regard to their own values and requirements. Similarly, as part of product development of organizations involved in a competitive industry such as software products, new development brings about backwards compatibility issues where in order to gain the full benefit of a significant new product upgrade, it is sometimes not possible to make it backwards compatible.

Consequently attempts at globalization and integration of financial and non-financial systems in different regions or across different divisions of an organization have been difficult to bring about due to the necessity of there being absolute compliance of all regions of the global economy or all management products within a particular market with one standard or system. This is as true in the area of collating financial data and non-financial data for multinational organizations as it is for national and local organizations.

In summary, areas of an organization requiring harmonization for either a global or local organization may include:
multiple financial and non-financial systems that are unrelated
multiple currencies
complex organizational structures
multiple entities
unrelated business lines
consolidation issues that may be physical, technical (in the sense of interfaces and data conversion requirements), or financial
timeliness to bring together information.

Analytic, diagnostic and reporting systems also have harmonization and complexity issues making them difficult to use. These issues include:
Slow access to information and long processing times involved in preparing reports
The need for technical skill of the user in knowing how to use the system and/or particular commands to access relevant information in undertaking analytic and diagnostic functions and compiling reports in relation to same
Difficulty in restricting user access to sensitive information without displaying the information to the user or limiting the ability to ‘slice and dice’ that information that may be necessary for particular analytic, diagnostic and reporting functions that the user should be able to perform
The expense of such systems and consequently the restricted usage of same
Security sensitivities given the nature and volume of information accessible to users
The propensity to use menu driven systems, making finding and running reports to be a complicated process
Limited ability for users to customise their reports in terms of rounding, formatting and currency settings at the time of running the reports
The ability to consolidate unrelated structured data into a single result.

### DISCLOSURE OF THE INVENTION

It is an object of the present invention to provide a system and method that can generate uniform reporting or analysis of a related set of discrete data sourced from a plurality of unrelated financial and non-financial systems, each compiled to comply with the same or a different set of requirements or business practices to the other.

In accordance with one aspect of the present invention, there is provided a data processing system for generating a related set of discrete data sourced from a plurality of financial or non-financial systems of an organization, or a combination of both, each compiled to comply with the same or a different set of business requirements or practices to the other, the system including:

data input means to receive raw data in relation to various business units of the organization sourced from the financial or non-financial systems of the organization;

first stage mapping means to map the raw data into a first database structure using a primary data dictionary detailing the mapped data according to prescribed parameters characterizing the organization and its business units in terms of its operational requirements as determined by the financial or non-financial systems; and

second stage mapping means to further map the first stage mapped data in the first database structure into a second database structure using a secondary data dictionary detailing the second stage mapped data according to prescribed groups characterizing the organization in terms of its management specification as determined by a preset of the management requirements of the organization, whereby the management specification can be derived from the first stage mapped data; and

wherein the management requirements of the organization are ascertained in accordance with the information required to manage different parts or aspects of the organization, the information being independent of, but overlapping with, the specification of the operational requirements of the organization.

Preferably, the prescribed parameters include sourced Systems, Chart of Accounts, Business Entities, Cost/Profit/Investment Centres, Projects/Jobs and Drivers.

Preferably, the first stage mapping means includes an integrity checking process to check the integrity of the first stage mapped data having regard to prescribed accounting requirements and reject the data if it is not verified.

Preferably, the integrity of the first stage mapped data is checked using the trial balance based on the chart of accounts of the financial system and is verified when the sum of the trial balance equals zero (debits equal credits).

Preferably, the prescribed groups include economic and reporting Groups, Divisions within all of the Groups, Geographic constraints and boundaries for reporting purposes, Business Entities, Cost Centres within all of the groups, Project Numbers within all of the groups, Account Numbers for Charts of Account and Account Balances.

Preferably, the second stage mapping means includes a further integrity checking process to check the integrity of the second stage mapped data, firstly having regard to its existence in the prescribed groups and providing a warning to allow for rectification of any problem identified if it does not exist, and secondly after the first check is successful, quarantining the second stage mapped data for limited access until verified as accurate and thereafter opening access to the second stage mapped data to permit reporting and analysis thereof.

Preferably, the data processing system includes an analytics and reporting engine to select options and filters to apply to the second stage mapped data from the second database structure and select and extract filtered data according to the applied options and filters to perform analytic and diagnostic functions, and output the filtered data in the form of a customised report.

Preferably, the analytics and reporting engine includes a filtering process to apply selected filters to selected groups of the second stage mapped data from the second database structure and produce a subset of structured data for subsequent analysis and diagnostic purposes.

Preferably, the analytics and reporting engine includes analyses processes to perform analytics and diagnostics on the subset of structured data, such as Ratio Analysis, Trend Analysis, Z-Scores, Diagnostic Flow Chart of the Business, Business Valuations, and risk and other proprietary analysis.

Preferably, the analytics and reporting engine includes an integrity checking process to check the integrity of the selected data back to the source data.

Preferably, the analytics and reporting engine includes a further integrity checking process to check the integrity of any report created by checking that the reported information balances to the source data.

Preferably, the data input means also receives supplemental data from an alternative source to be mapped by the first stage mapping means along with the received raw data, the supplemental data representing innate characteristics of the organization that are not directly derivable from the raw data.

In accordance with another aspect of the present invention, there is provided a method for generating a related set of discrete data sourced from a plurality of financial or non-financial systems of an organization, or a combination of both, each compiled to comply with the same or a different set of business requirements or practices to the other, the system including:

receiving raw data in relation to various business units of the organization sourced from the financial or non-financial systems of the organization;

mapping the raw data into a first database structure using a primary data dictionary detailing the mapped data according to prescribed parameters characterizing the organization and its business units in terms of its operational requirements as determined by the financial or non-financial systems;

further mapping the first stage mapped data in the first database structure into a second database structure using a secondary data dictionary detailing the second stage mapped data according to prescribed groups characterizing the organization in terms of its management specification as determined by a preset of the management requirements of the organization, whereby the management specification can be derived from the first stage mapped data; and

wherein the management requirements of the organization are ascertained in accordance with the information required to manage different parts or aspects of the organization, the information being independent of, but overlapping with, the operational requirements of the organization.

### BRIEF DESCRIPTION OF THE DRAWINGS

The invention will be better understood in the light of the flowing description of the best mode for carrying out the invention. The description is made with reference to the following drawings of a specific embodiment of the best mode, wherein:

FIG. 1 is a schematic diagram of the client/server embodiment of the data processing system in an Internet environment;

FIG. 2 is a schematic block diagram of the general structure of the server of FIG. 1;

FIG. 3 is flow chart showing the application of the data processing system to an organization having deployed independent sets of financial and non-financial systems for discrete business activities in three different countries;

FIG. 4 is a flow chart showing the specific data processing stages performed by the data processing system in processing source data to reporting data in accordance with the specific embodiment of the best mode;

FIG. 5 is an example of use of the data processing system in relation to a set of financial data mapping it from a chart of accounts in the source systems to a chart of accounts meeting standards of various compliance bodies and also to a chart of accounts meeting standards of various statutory bodies;

FIG. 6 is a block diagram showing the various types of reports that the analysis and reporting engine is capable of generating for various users of the organization;

FIG. 7 is a block diagram showing an overview of the data processing stages undertaken by data processing system at the input end;

FIG. 8 is a flow chart showing the configuration process undertaken by an administrator using the data processing system to configure the system for a particular client;

FIG. 9 is flow chart diagram showing the processes of the output end of the data processing system performed by the analytics and reporting engine for configuring the output end for use by authorised users of a client and how data is extracted from the second file into a report, analysis or diagnostic;

FIG. 10 is a screen shot of the ribbon display of the interactive dashboard interface of the system; and

FIG. 11 is a flowchart diagram showing how the data processing system is connected to pre-existing data transactional systems and how the methodology of producing a specified Output differs.

### BEST MODE(S) FOR CARRYING OUT THE INVENTION

The best mode for carrying out the invention is described with respect to one specific embodiment directed towards a data processing system and method for generating an organizationally related set of discrete data sourced from a plurality of financial or non-financial systems of an organization, or a combination of both, each compiled to comply with the same or a different set of business requirements or practices to the other.

The data processing system generally has an input end to generate data in a structured data set for subsequent analysis or report production for an organization and various users of that data associated with that organization, and an output end to provide an interface for authorized client and advanced users to update the data and perform such analysis or report production for their purposes on an ongoing basis.

The data processing system in the present embodiment sits over one or more pre-existing transaction processing systems that produce financial and/or non-financial data that collectively constitutes big data, which is stored in a data store. This big data characterises the organization and its business units in terms of its operational requirements or practices. These include internal reporting requirements and analysis and/or diagnostics of non-financial data, and/or regulatory specification as determined by statutory and non-statutory reporting requirements, and/or by particular customised ERP systems designed specifically for a particular service, manufacturing or other sector.

These pre-existing transaction processing systems have a tendency to be strongly proprietary, having their own reporting and analysis systems, which are constrained by the information residing in their own database structures, and dictate to the user what can or cannot be reported on and is able to be analysed. SAP™ and ORACLE™ are examples of such proprietary transaction processing systems, where reporting and analysis tends to be restrictive, cumbersome and time intensive.

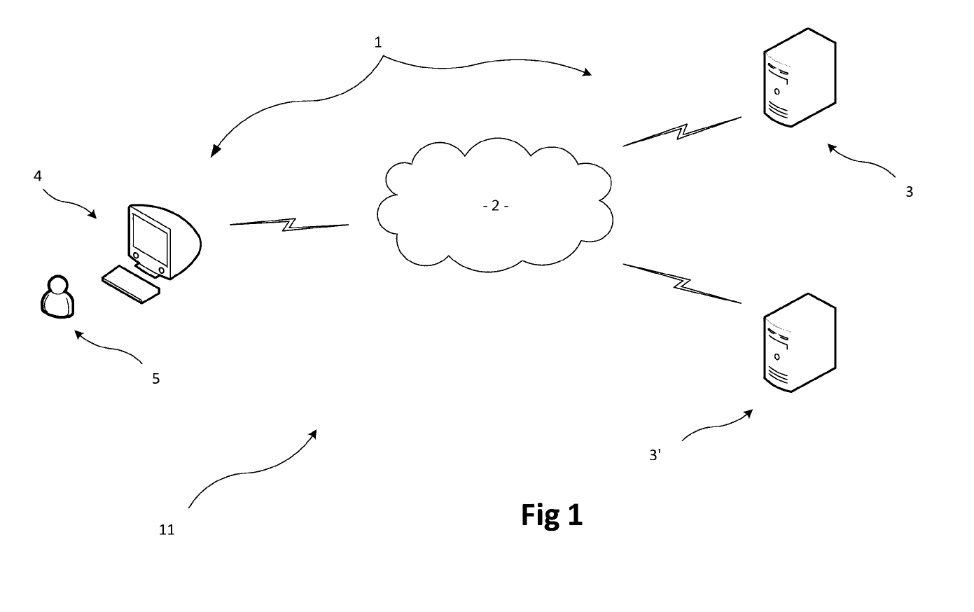

In the present embodiment as shown in FIG. 1, the data processing system 11 comprises a client/server arrangement 1 disposed in an Internet environment 2, which can take advantage of cloud computing resources. In this arrangement, a server 3 can be hosted remotely of a client 4 and include high power computing services with appropriate speed and processing power to service a large number of clients located in different geographical locations. The client 4 can be any suitable computing device by which a user 5 can access the server 3 using a browser.

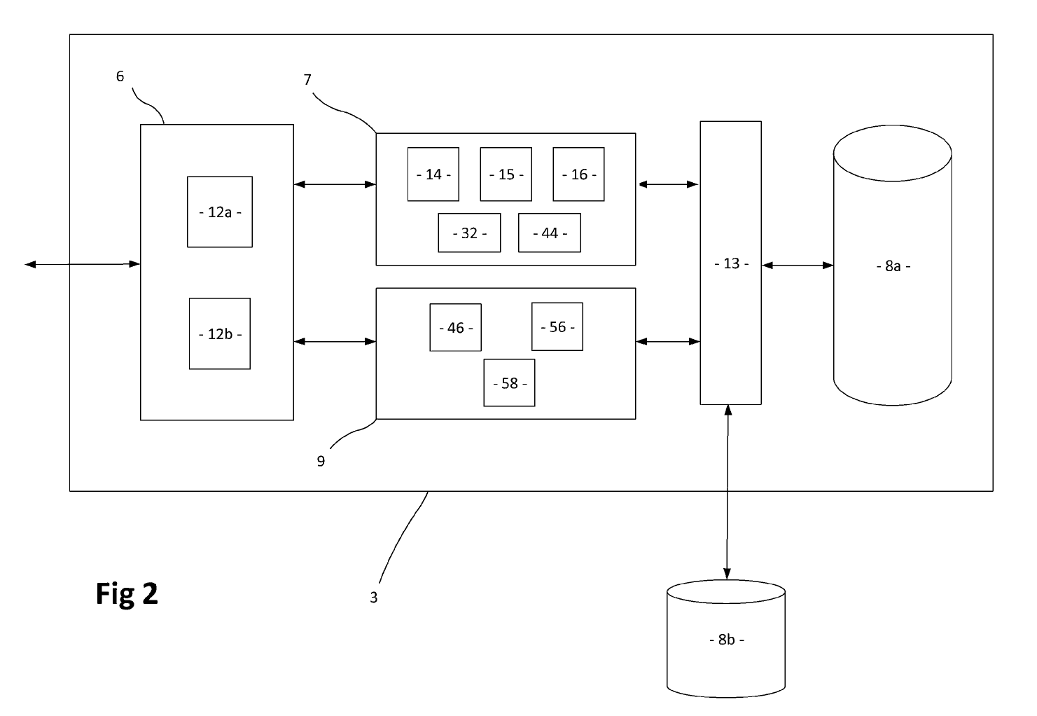

The server 3, as shown in FIG. 2, includes a communication module 6, a data processing engine 7, a data store 8 and an analytics and reporting engine 9. The data store 8 includes a local store 8a serving as a cache, and a remote store 8b. The remote store 8b can itself be hosted remotely by another server 3′ and be part of the data processing system 11 where the big data is generated and stored within a server bank where large volumes of big data may be cost effectively stored and retrieved. By way of this arrangement, big data can be retrieved from the remote store 8b for local storage within the cache of the local store 8a, where it can be rapidly accessed, depending upon the needs of the users 5, as determined and controlled by the analytics and reporting engine 9.

The data processing system 11 operates in three different modes. Firstly it operates in:
(i) a setup mode concerned with the input end of the system for an administrative user to establish mapping rules to map essentially raw data characterising an organisation and its business units in terms of its operational requirements or practices to transform the raw data to big data according to the mapping rules, which is stored in the data store. 8;
(ii) a runtime mode where the mapping rules established during the setup mode for an organization are subsequently used for updating the big data from new raw data by administrative and/or advanced client users, and apply real time conversions to certain data to enable reporting of the financial and non-financial data to a client user and analysis and/or diagnostics of that data by the client user; and
(iii) an output mode during which a client user or advanced client user accesses the big data of the organization to filter the big data and obtain reports and perform analytics and/or diagnostics on the filtered data using the user interface.

The communication module 6 is in communication with the data processing engine 7 during the setup mode and the analytics and reporting engine 9 during the runtime mode and the output mode. The communication module 6 provides for communication between the server 3 and the various users 5 via the Internet 2, using one or more user interfaces 12 depending upon the type of the user and the mode of operation of the data processing system 11. In the present embodiment, the communication means uses a setup interface 12a for an administrative user to access the data processing system 11 during the setup mode, and a standard interface 12b for client users or advanced client users to access the data processing system during the runtime and output modes. In another embodiment, the same user interface is used during all modes, but is designed to provide different access privileges to different engines, depending upon the type of the user.

Both the data processing engine 7 and the analytics and reporting engine 9, depending upon the mode of operation of the data processing system 11, have access to data in both the local store 8a and the remote store 8b via a database management system 13 such as SQL Server™.

The input end of the data processing system 11 operates during the setup mode and generally comprises a data input means 14, first stage mapping means 15 and second stage mapping means 16.

The data input means 14 is specifically programmed to receive the raw data from the various business units of the organization, as sourced from the various financial and non-financial systems of the organization.

The first stage mapping means 15 is specifically programmed to map the raw data into a first database structure stored within the data store 8 using a primary data dictionary detailing the mapped data according to prescribed parameters. The parameters are designed to characterize the organization and its business units in terms of its operational requirements as determined by the financial or non-financial systems and typically include Systems, Chart of Accounts, Business Entities, Cost/Profit/Investment Centres, Projects/Jobs and Drivers.

The second stage mapping means 16 is specifically programmed to further map the first stage mapped data in the first database structure into a second database structure also stored within the data store 8 using a secondary data dictionary detailing the second stage mapped data according to prescribed groups to form a data pool. The groups are designed to characterize the organization in terms of its management specification as determined by a preset of the management requirements of the organization and typically include economic and reporting Groups, Divisions within all of the Groups, Geographic constraints and boundaries for reporting purposes, Business Entities, Cost Centres within all of the groups, Project Numbers within all of the groups, Account Numbers for Charts of Account and Account Balances.

The management specification is derived from the first stage mapped data, and the management requirements of the organization are ascertained in accordance with the information required to manage different parts or aspects of the organization. This information is independent of, but overlaps with, the specification of the operational requirements of the organization.

The setup interface 12a used by the input end is particularly designed for an administrative user to access the data processing engine 7 and design the appropriate mapping rules for the first and second stage mapping of data that can be established for subsequent operation of the data processing system 11 by client users and advanced client users in the runtime and output modes.

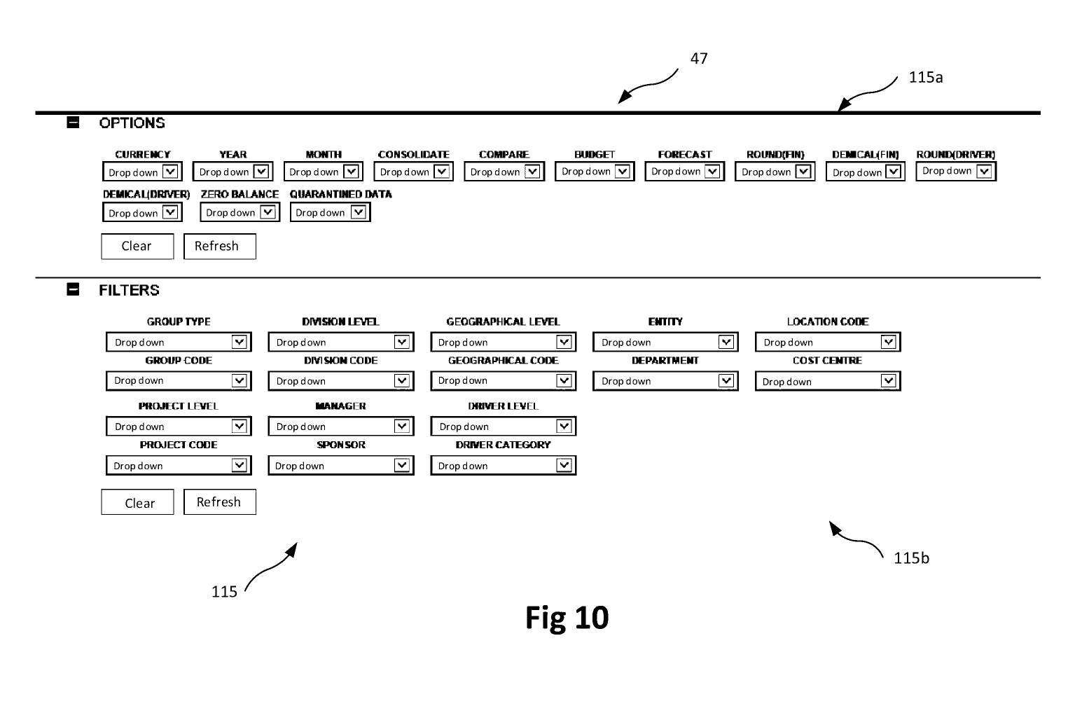

The standard interface 12b generates a display to a client user or advanced client user in the form of an interactive dashboard interface 47, as shown in FIG. 10 of the drawings. The display enables a client user or advanced client user to input control data via the analytics and reporting engine 9 to the database management system 13 to access the big data stored on the data store 8, and for outputting filtered data received from the database management system in response to the access. More particularly, the database management system 13 accesses the data store 8 in accordance with the commands of the control data received via the display, and retrieves filtered data from the big data stored in the data store in response to the commands of the control data, and provides the filtered data to the standard interface 12b for outputting to the client user or advanced client user in a suitable format. Thus the data processing system allows the client user or advanced client user to conveniently access the big data in the data store 8 by way of the standard interface 12b, and output filtered data in a conveniently readable form to the client user or advanced client user, independently of the pre-existing transaction processing system.

The input end is essentially concerned with receiving raw data from the financial and non-financial systems of the organization which characterizes the organization and its business units in terms of its operational requirements or practices including:
(i) internal reporting requirements and analysis and/or diagnostics of both financial and non-financial data: and/or
(ii) regulatory specification as determined by statutory and non-statutory reporting requirements or standards that have been developed.

For example, these may be determined by IFRS or GAAP accounting standards adopted by the country or region where the organization has a business activity, and/or by particular customized ERP systems such as SAP™ or ORACLE™ designed specifically for a particular service, manufacturing or other sector.

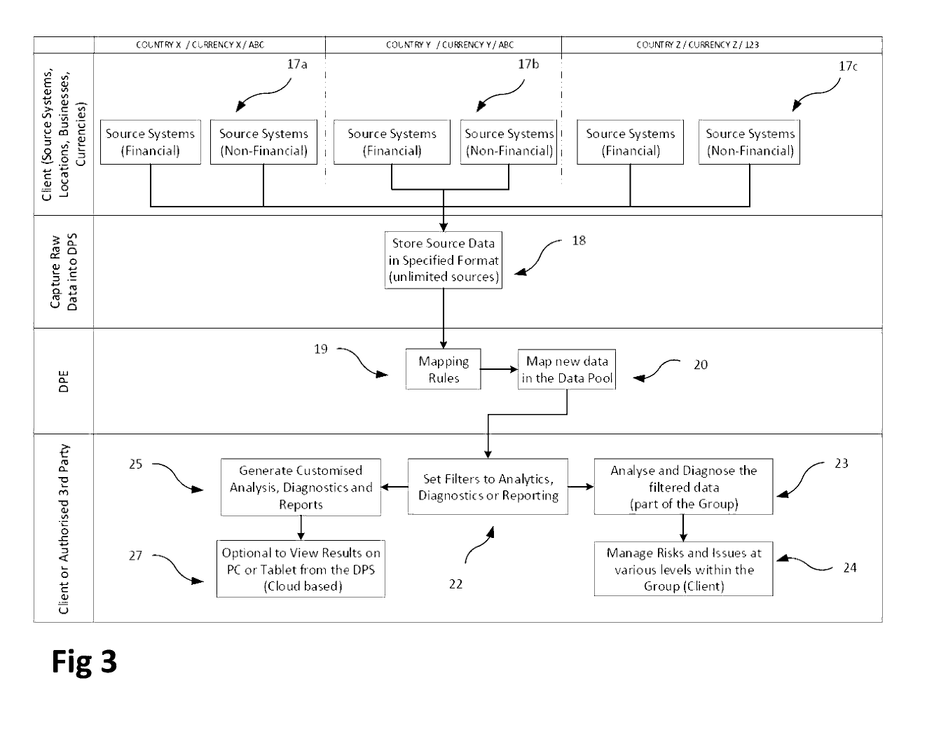

An example of the methodology followed for processing the data by an administrative user, is shown in FIG. 3. The organization, referred to as a client, has business activities in a number of countries, Country X, Country Y and Country Z. Each of these countries have their own currency, Currency X, Currency Y and Currency Z. The business activity in Countries X and Y is the same, generally described as ABC in each case. The business activity in Country Z is different from the business activity in Countries X and Y, and is described as 123.

Each of the business activities of the client in each of the countries is indicated in the top row and each has its own financial and non-financial source systems 17a, 17b and 17c respectively. These source systems characterize the client having regard to its location, business activities and currencies and take the form of multiple financial systems of different currencies, and multiple non-financial systems having different business drivers underlying the different business activity, historical information and current information. As previously described, this characterizes the client and its business units in terms of its operational requirements at the lowest level of data granularity of the client.

The second row of FIG. 3 involves using the data processing engine 7, where source data is captured and received from these source systems 17 by the data input means 14 of the data processing engine and is stored in a specified format at 18 in the data store 8 pursuant to the first stage of mapping performed by the first stage mapping means 15, which will be described in more detail later. Essentially this first stage of mapping captures all relevant data that is necessary for subsequent reporting having regard to a preset of management requirements of the client. Preset refers to these management requirements being ascertained beforehand, in accordance with the information required by the client to manage different parts or aspects of the client and thus characterize the client in terms of its management specification, quite independent of the operational requirements of the client. However, as this information is originally sourced from the financial and non-financial systems of the client, the information overlaps with the specification of the operational requirements of the client.

The third row also involves using the data processing engine 7, where the data processing engine performs the second stage of mapping the data stored in the specified format at 18, by the second stage mapping means 16 using mapping rules 19 that map the data into a new structured data set forming the data pool at 20 that is stored within the data store 8. The mapping rules 19 are detailed according to prescribed groups that characterize the organization in terms of its management specification. The prescribed groups will be described in more detail later.

The fourth row is concerned with the output end of the system and includes using the analytics and reporting engine 9, where the client or an authorised third party is able to set filters to undertake particular analytics, diagnostics or reporting at 22 based on the new structured data set constituting the data pool. After setting the filters, the analytics and reporting engine 9 provides for analysing and diagnosing the filtered data as part of the overall group of data at 23. This enables the client or authorised third party to manage risks and issues at various levels within the particular group of the client as shown at 24.

Alternatively, or additionally, the reporting and analytics engine 9 after setting of the filters at 22, is selected to generate customised analysis, diagnostics and reports at 25, with the option to view the results on an appropriate media such as a PC, or tablet from a cloud based setup at 27.

Examples of the analytics and diagnostics that can be performed include, but are not limited to, forecasting, budgeting, ratio analysis, diagnostic flow charts, risk management, business valuations and Z-Scores. Examples of the reporting that can be performed include customised management reporting including historical information, board reporting, compliance reporting and statutory reporting, in full or part.

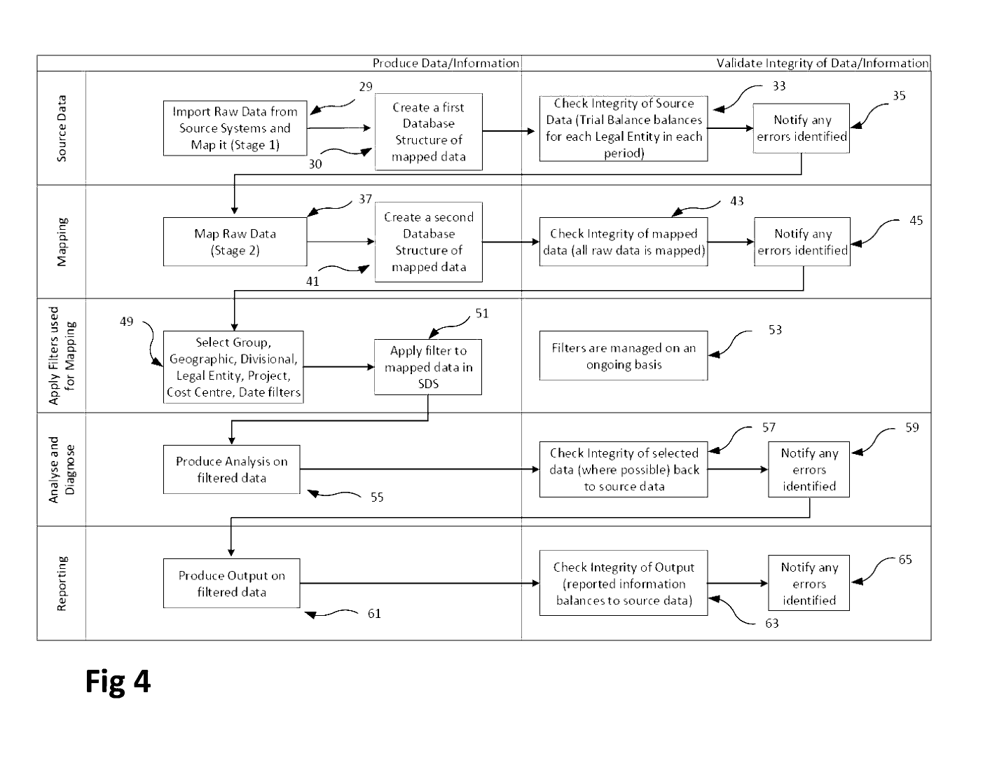

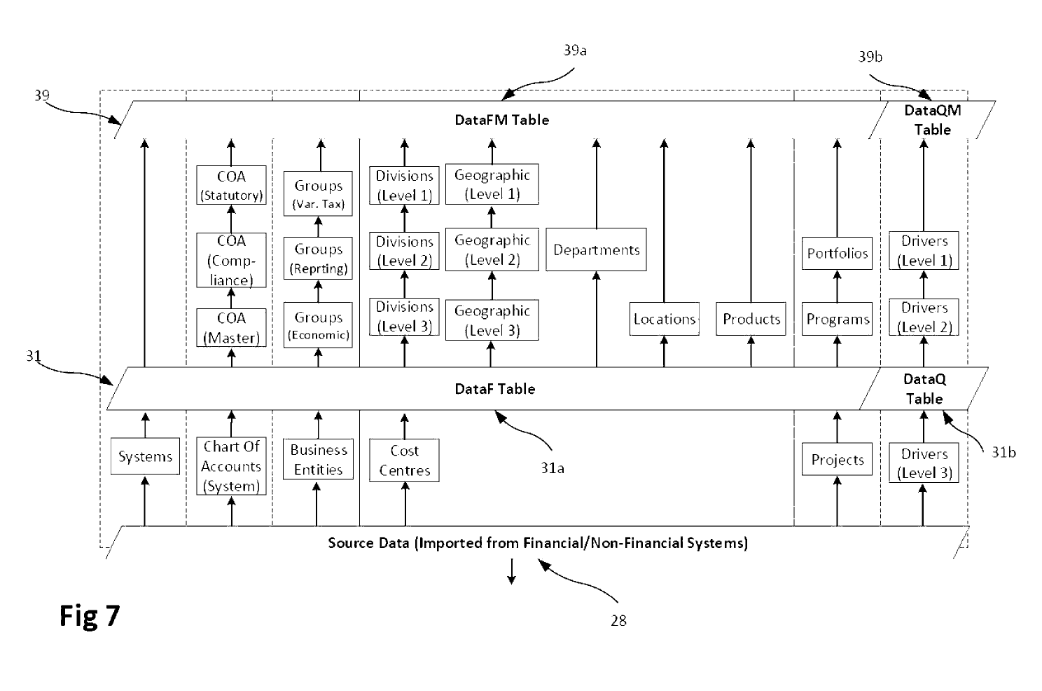

Now describing the process flow in more detail, reference is made to FIG. 4 of the drawings, which provides a marginally expanded view of the rows shown in FIG. 3. In the first row, source data 28 (shown in FIG. 7) is imported in the form of the raw data from the various source systems 17 as shown at 29, and is mapped by the first stage mapping means 15 during the first mapping stage into a first database structure 31 as shown at 30. It is stored in the specified format in the data store 8 by the database management system 13, creating a first structured data set of mapped data. The data status of these first staged mapped entries is set to ‘Imported’.

In the present embodiment, the source data 28 consists of detailed Trial Balance data which details the month and year associated with the data, the particular source System, Business Entity, Cost/Profit/Investment centre, Project Number, Account Number of the system Chart of Accounts, and the account balance of the system Chart of Accounts for the client. This source data 28 is mapped using a primary data dictionary forming part of the first stage mapping means 15 detailing the mapped data according to prescribed parameters characterizing the client and its business units in terms of its operational requirements as determined by both the financial and non-financial systems of the client. These prescribed parameters also include innate characteristics of the client provided by supplemental data that is not directly derivable from the raw data. For example this supplemental data might be the country or region of the particular business entity of the client, which may not be directly derivable from the source data 28, but is implicit in knowing the address of the particular business entity concerned. The prescribed parameters will be described in more detail later.

Within this database, the data is subjected to checking by an integrity checking process 32 of the data processing engine 7, whereby the integrity of the source data 28 derivable from the financial systems is checked at 33 having regard to prescribed accounting requirements in the form of Trial Balance balances for each business entity of the client within each period covered by the Trial Balance. If the sum of the Trial Balance equaling zero is not verified by the data processing system for each business entity and period involved, the data is rejected and the client or the operator is notified of errors that are identified at 35. It also checks whether there are any more entries with the status ‘Imported’ and if there are, similarly the data is not verified, the client or operator notified and the data rejected. If no errors are found, then the data status is changed to Transferred′ and the data processing means proceeds to the second stage of mapping.

In the second row, the second stage mapping is undertaken by the second stage mapping means 16 of the data processing engine 7, whereby the first stage mapped data in the first database structure 31 is further mapped at 37 according to the mapping rules 19 into a second database structure 39 (shown in FIG. 7, creating a second structured data set of mapped data at 41) to form the data pool as previously described. This further mapping is undertaken using mapping rules in the form of a secondary data dictionary detailing the second stage mapped data according to prescribed groups characterizing the organization in terms of its management specification as determined by the preset of management requirements of the client. These prescribed groups include: economic and reporting Groups, Divisions within all of the groups, Geographic constraints and boundaries for reporting purposes, Business Entities, Cost/Profit/Investment centres within all of the groups, Project/Job Numbers within all of the groups, Account Numbers for charts of accounts and account balance.

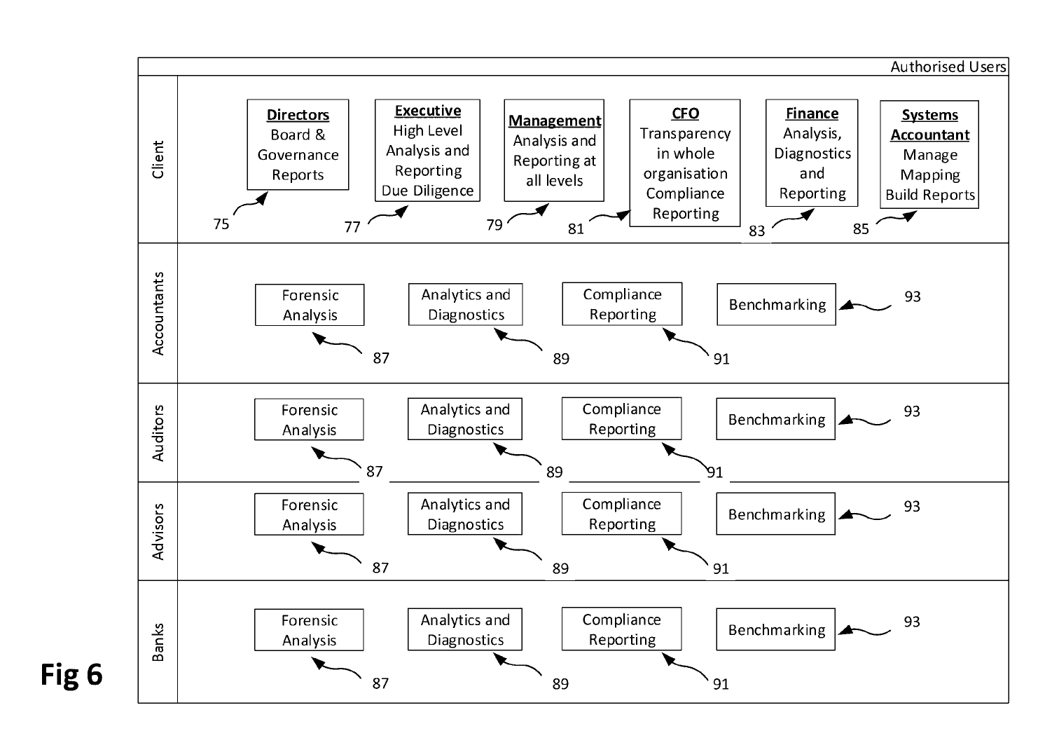

The data processing engine 7 also checks the integrity of the second stage mapped data in two stages at 43 using a further integrity checking process 44. Firstly, the further integrity checking process 44 has regard to the existence of data values in the primary data dictionary containing the prescribed groups, in particular the System, Business Entity, Cost/Profit/Investment Centre, Project/Job and Account Number groups, where the absence of data will cause mapping errors. If any errors are found, the further integrity checking process 44 will display a warning message at 45 to the administrative user (or advanced client user when operated in the runtime mode) indicating that there are issues with the data that need to be rectified. In addition to checking that data values exist, the further integrity checking process 44 at 43 checks that there are no remaining entries with the status Transferred′, which would indicate that these entries have been unmapped. If any errors are detected, the further integrity checking process invokes a routine that allows for rectification of the problem by permitting the administrative user or advanced client user to add the new System, Business Entity, Cost/Profit/Investment centre, Project/Job and/or Account Number data to the relevant dictionary and remap those entries and/or those that still have their status showing as Transferred′. Secondly, after the first check has completed successfully, the further integrity checking process 44 at 43 changes the data status to ‘Quarantined’, quarantining the second stage mapped data for limited access until verified as accurate. The further integrity checking process 44 restricts viewing of the quarantined data making it visible only to advanced client users (shown in FIG. 6), such as CFO, Finance and Systems Accountant, to verify that the data is accurate. When all mapping errors have been rectified and the numbers are verified as correct, the further integrity checking process 44 changes the data status to ‘Mapped’ and client users are able to see and use the data in reporting, diagnostic and analysis processes subsequently.

The third row shows the start of the output end of the data processing system 11, which involves the analytics and reporting engine 9 invoking a filtering process 46 to apply filters to the second stage mapped data that has been successfully further mapped. The standard user interface 12b presents an interactive dashboard interface 47 (see FIG. 10) to the client user or advanced client user, which will be described in more detail later. Using this dashboard interface 47, the user may select one or more of the prescribed groups at 49, such as Group, Geographic, Divisional, Business Entity, Project/Job, Cost Centre and Date and select the filter or filters to apply. The filtering process 46 is then invoked to apply the selected filter(s) to the selected group(s) of the second stage mapped data in the data pool stored within the second database structure 39 at 51 to produce a subset of structured data for subsequent analysis and diagnostic purposes by the user, as shown in the fourth row. These filters are managed on an ongoing basis at 53 by checking the data dictionaries to ensure that there is integrity to the information produced. The dictionaries are managed by either the administrative user or an advanced client user depending on the particular groups selected and the options that are selected for client management. Sophisticated clients may have the ability to manage the mapping facility, while less sophisticated users may opt for this process to be managed for them to avoid errors or poor choices.

The fourth row shows the operation of the analysis and diagnosis stage as performed by the analytics and reporting engine 9 when invoked to initially produce analysis on the filtered data at 55. The analytics and reporting engine 9 is designed to perform any predetermined analytics or diagnostics that could be applied to the subset of structured data using one or more analyses processes 56 provided by the analytics and reporting engine. These analyses processes 56 are designed to have regard to the well-known ‘Four Pillars’ of the information processing model, which are Thinking, Analysis of stimuli, Situational modification and Obstacle evaluation. This is achieved by the analyses processes 56 including dedicated processes that can perform, but are not limited to:
Ratio Analysis
Trend Analysis
Z-Scores
Diagnostic Flow Chart of the Business
Business Valuations
Results of the analysis/diagnostics fed into a Risk Matrix (ISO 31000) where a level of Risk is determined which is placed in a ‘Risk Register’ and managed by the client.

The analytics and reporting engine 9 at 57 includes its own analytics and reporting (AR) integrity checking process 58 that checks the integrity of selected data, where possible, back to the data pool comprising the second stage mapped data in the second database structure 39. This is done by the AR integrity checking process 58 checking that the ‘sum of the parts’ equals the whole, where the totals in the analysis as derived by calculations, equals the sum of the records extracted from the database. Any errors are notified to the user at 59.

If successful, the analytics and reporting engine 7 then proceeds, as shown in the fifth row being the Reporting stage, to produce a specified Output on the filtered data at 61.

The analytics and reporting engine 9 then proceeds to invoke the AR integrity checking process 58 again to check the integrity of any specified Output by checking that the Output information reconciles to the data pool in the second database structure 39 at 63, in a similar manner to the integrity checking conducted by the AR integrity checking process 56 at 57. Accordingly the user is notified of any errors identified at 65.

It should be noted that the specified Output during this Reporting stage is not limited to just reporting functions based on the data pool, but includes all manner of analysis and diagnostics that can be performed by the output end as previously described.

Importantly the processing of an organizations financial and non-financial data in this manner provides significant utility in that the data processing system 11 can not only provide the ability for the client to perform customised internal analytics, diagnostics and reporting across an organizations different business units from the mapped data pool, but also external analytics, diagnostics and reporting from the same data pool. Thus Management Reporting that reflects the operations of the organization's business anywhere between the consolidated Group down to individual Cost/Profit/Investment Centres or Projects/Jobs is able to be provided, and this same information can be replicated in manner to produce information for compliance bodies as a consequence of mapping to compliance systems, i.e. Compliance Reporting (e.g. Treasury in government), and information that forms part of the statute reporting requirements such as Annual Reports, i.e. Statute Reporting. In this respect, Statute Reporting and Compliance Reporting both are dependent on the quality of the mapped data in the data pool, so the data integrity checking facilities of the data processing system 11 are designed to satisfy this requirement.

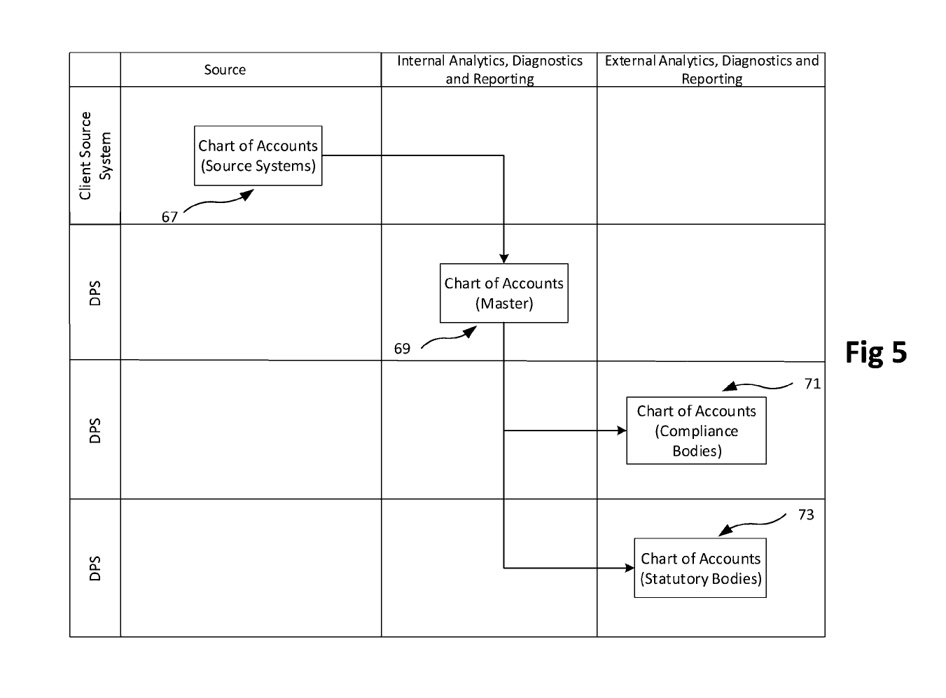

This transformation of data from the client source systems to the internal and external Outputs described above is shown in FIG. 5. There are essentially three stages in this process having regard to the charts of accounts of the financial systems of the client. Firstly, the client's source systems provide data from the source Chart of Accounts at 67 to the data processing system 11. Possible uses of the source Chart of Accounts include:
Replicating existing reporting
Develop new reports at system level not possible with existing systems
Validating source system integrity
Backup of financial reporting records
Remote access to information which may be cloud based.

Secondly, the data processing system 11 maps the source Chart of Accounts to a master Chart of Accounts at 69 using the mapping rules 19 previously established by the input end of the data processing system 11 to form part of the data pool. Internal analytics, diagnostics and reporting are performed on this data pool. Possible uses of the data from the master Chart of Accounts include:
Customised management reporting
Board reporting and other governance reporting
Restructuring organization reporting without modifying source systems
Forensic tool for investigating and auditing
Due diligence such as analysing potential takeover targets
Correctly determining if hurdles are achieved or breached (i.e. banks/lenders)
Planning and forecasting
Remote access to information which may be cloud based.

Thirdly, once the master Chart of Accounts is created, then the data processing system 11 maps this data into a Chart of Accounts for compliance body reporting at 71 and/or statutory body reporting at 73 using the analytics and reporting engine 9. The compliance reporting is performed using external analytics, diagnostics and reporting functions. Possible uses of using the data from the Chart of Accounts for compliance bodies includes:
Producing information from the original source and preventing manipulation of same
Analysing information to ensure that compliance is achieved
Correctly determining if hurdles are achieved or breached
Benchmarking for industry or class from multiple clients
Forensic tool for investigating
Auditing.

Possible uses for the data from the Chart of Accounts for statutory bodies includes:
Statutory reporting requirements
Auditing
Forensic tool for investigating
Benchmarking for industry or class from multiple clients.

The different types of client users of the system and the functions set to be performed by them in the present embodiment of the invention are shown in FIG. 6 of the drawings. Users are shown in successive rows and include the client, accountants, auditors, advisors and banks. The client is divided up into Directors 75 who are involved with Board and Governance Reports, Executive 77 who are involved with high level analysis and due diligence reporting, Management 79 who are involved with analysis and reporting at all levels, Chief Financial Officer (CFO) 81 who is involved with ensuring transparency in the whole organization by way of Compliance Reporting, Finance 83 who is involved with analysis, diagnostics and reporting activities, and Systems Accountant 85 who is involved with managing mapping functions and building reports.

The other authorised users each perform forensic analysis functions 87, analytics and diagnostics functions 89, compliance reporting functions 91 and benchmarking functions 93 as indicated.

FIG. 7 provides a more detailed overview of the two mapping stages undertaken by the data processing system 11 at the input end of the system. Source data 28 imported from the financial systems 17 is mapped into the first database structure 31 during the first mapping stage using the primary data dictionary detailing the mapped data: (i) in a financial data table 31a according to the prescribed parameters of the financial systems including: Systems, the system Chart of Accounts, Business Entities, Cost/Profit/Investment Centres and Projects/Jobs; and (ii) in a non-financial quantitative data table 31b according to the prescribed parameters of the non-financial systems being the Business Drivers as indicated, and also Systems, Business Entities, Cost Centres and Projects (not shown) in a similar manner to the corresponding financial data table parameters.

An example of this is shown in the following tables A, B and C where Table A shows separate Charts of Account for Companies X, Y and Z of FIG. 3 in Tables A.1, A.2 and A.3, respectively, the companies adopting three different Systems, namely System 1, System 2 and System 3, and being based in three different Countries X, Y and Z, respectively. These system Charts of Account are mapped into a master Chart of Accounts shown in Table A.4.

The source data 28 is presented in the form of Trial Balances shown in Tables B.1, B.2 and B.3 respectively obtained from the Charts of Account shown in Tables A.1, A.2. and A.3, which is in the prescribed format ready for importing by the data processing engine 7.

### TABLE A

TABLE A.1
CHART OF ACCOUNTS (COMPANY
X, SYSTEM 1, COUNTRY X)

| Account (Company X) | Account Name |
|---|---|
| A100 | Bank |
| A110 | Debtors |
| L200 | Creditors |
| E300 | Equity |
| E310 | Retained Earnings |
| R400 | Sales |
| R500 | Expenses |

TABLE A.2
CHART OF ACCOUNTS (COMPANY
Y, SYSTEM 2, COUNTRY Y)

| Account (Company Y) | Account Name |
|---|---|
| 1 | Bank |
| 2 | Debtors |
| 3 | Creditors |
| 4 | Equity |
| 5 | Retained Earnings |
| 6 | Sales |
| 7 | Expenses |

TABLE A.3
CHART OF ACCOUNTS (COMPANY
Z, SYSTEM 3, COUNTRY Z)

| Account (Company Z) | Account Name |
|---|---|
| 100 | Bank |
| 101 | Debtors |
| 102 | Creditors |
| 103 | Equity |
| 105 | Retained Earnings |
| 200 | Sales |
| 201 | Expenses |

TABLE A.4
CHART OF ACCOUNTS (MASTER)

| Account (Master) | Account Name |
|---|---|
| 100 | Bank |
| 101 | Debtors |
| 102 | Creditors |
| 103 | Equity |
| 105 | Retained Earnings |
| 200 | Sales |
| 201 | Expenses |

### TABLE B

TABLE B.1
TRIAL BALANCE (COMPANY X) PRESCRIBED
FORMAT FOR IMPORT

| Month | Year | System | Entity | CC | Proj | Account | Amount |
|---|---|---|---|---|---|---|---|
| 12 | 2014 | 1 | 101 | 211 | | A100 | 80 |
| 12 | 2014 | 1 | 101 | 212 | | A100 | 20 |
| 12 | 2014 | 1 | 101 | 211 | | A110 | 150 |
| 12 | 2014 | 1 | 101 | 212 | | A110 | 80 |
| 12 | 2014 | 1 | 101 | | 123 | A110 | 20 |
| 12 | 2014 | 1 | 101 | 211 | | L200 | −200 |
| 12 | 2014 | 1 | 101 | 211 | | E300 | −100 |
| 12 | 2014 | 1 | 101 | 211 | | E310 | −30 |
| 12 | 2014 | 1 | 101 | 212 | | E310 | −20 |

TABLE B.2
TRIAL BALANCE (COMPANY Y) PRESCRIBED
FORMAT FOR IMPORT

| Month | Year | System | Entity | CC | Proj | Account | Amount |
|---|---|---|---|---|---|---|---|
| 12 | 2014 | 2 | 102 | 221 | | 1 | 160 |
| 12 | 2014 | 2 | 102 | 222 | | 1 | 40 |
| 12 | 2014 | 2 | 102 | 221 | | 2 | 300 |
| 12 | 2014 | 2 | 102 | 222 | | 2 | 160 |
| 12 | 2014 | 2 | 102 | | 124 | 2 | 40 |
| 12 | 2014 | 2 | 102 | 221 | | 3 | −400 |
| 12 | 2014 | 2 | 102 | 221 | | 4 | −200 |
| 12 | 2014 | 2 | 102 | 221 | | 5 | −60 |
| 12 | 2014 | 2 | 102 | 222 | | 5 | −40 |

TABLE B.3
TRIAL BALANCE (COMPANY Z) PRESCRIBED
FORMAT FOR IMPORT

| Month | Year | System | Entity | CC | Proj | Account | Amount |
|---|---|---|---|---|---|---|---|
| 12 | 2014 | 3 | 103 | 231 | | 100 | 120 |
| 12 | 2014 | 3 | 103 | 232 | | 100 | 30 |
| 12 | 2014 | 3 | 103 | 231 | | 110 | 225 |
| 12 | 2014 | 3 | 103 | 232 | | 110 | 120 |
| 12 | 2014 | 3 | 103 | | 125 | 110 | 30 |
| 12 | 2014 | 3 | 103 | 231 | | 200 | −300 |
| 12 | 2014 | 3 | 103 | 231 | | 300 | −150 |
| 12 | 2014 | 3 | 103 | 231 | | 310 | −45 |
| 12 | 2014 | 3 | 103 | 232 | | 310 | −30 |

Table C shows the first stage mapped data as it would be stored in the financial data table 31a of the first database structure 31 after the first mapping process.

TABLE C
File mapped stage 1 (Financial Data)

| Month | Year | System | Entity | CC | Proj | Account | Amount |
|---|---|---|---|---|---|---|---|
| 12 | 2014 | 3 | 103 | 231 | | 100 | 120 |
| 12 | 2014 | 3 | 103 | 232 | | 100 | 30 |
| 12 | 2014 | 3 | 103 | 231 | | 110 | 225 |
| 12 | 2014 | 3 | 103 | 232 | | 110 | 120 |
| 12 | 2014 | 3 | 103 | | 125 | 110 | 30 |
| 12 | 2014 | 3 | 103 | 231 | | 200 | −300 |
| 12 | 2014 | 3 | 103 | 231 | | 300 | −150 |
| 12 | 2014 | 3 | 103 | 231 | | 310 | −45 |
| 12 | 2014 | 3 | 103 | 232 | | 310 | −30 |
| 12 | 2014 | 1 | 101 | 211 | | A100 | 80 |
| 12 | 2014 | 1 | 101 | 212 | | A100 | 20 |
| 12 | 2014 | 1 | 101 | 211 | | A110 | 150 |
| 12 | 2014 | 1 | 101 | 212 | | A110 | 80 |
| 12 | 2014 | 1 | 101 | | 123 | A110 | 20 |
| 12 | 2014 | 1 | 101 | 211 | | L200 | −200 |
| 12 | 2014 | 1 | 101 | 211 | | E300 | −100 |
| 12 | 2014 | 1 | 101 | 211 | | E310 | −30 |
| 12 | 2014 | 1 | 101 | 212 | | E310 | −20 |
| 12 | 2014 | 2 | 102 | 221 | | 1 | 160 |
| 12 | 2014 | 2 | 102 | 222 | | 1 | 40 |
| 12 | 2014 | 2 | 102 | 221 | | 2 | 300 |
| 12 | 2014 | 2 | 102 | 222 | | 2 | 160 |
| 12 | 2014 | 2 | 102 | | 124 | 2 | 40 |
| 12 | 2014 | 2 | 102 | 221 | | 3 | −400 |
| 12 | 2014 | 2 | 102 | 221 | | 4 | −200 |
| 12 | 2014 | 2 | 102 | 221 | | 5 | −60 |
| 12 | 2014 | 2 | 102 | 222 | | 5 | −40 |

During the second mapping stage the data values are mapped into the second database structure 39 using the secondary data dictionary detailing the further mapped data: in a financial management data table 39a according to the prescribed groups of the financial systems including: the master Chart of Accounts, compliance Chart of Accounts, statutory Chart of Accounts, economic Groups, reporting Groups, various tax Groups, different level Divisions, different level Geographic, Departments, Locations, Products and Programs and Portfolios as indicated; and in a non-financial quantitative management data table 39b according to the prescribed groups of the non-financial systems, being the different level Business Drivers, as indicated, and also Groups, Divisions, Geographic, Departments, Locations, Products and Programs (not shown) in a similar manner to the corresponding financial data table groups.

Consistent with the example shown in Tables B and C, Table C shows an example of how the second stage mapped data would be further mapped and stored in the financial management data table 39a of the second database structure 39.

TABLE D
File with mapped second stage (financial data)

| Month | Year | System | Entity | CC | Proj | S. Acc. | Amount | M. Acc | Dept. | Country | Prod. |
|---|---|---|---|---|---|---|---|---|---|---|---|
| 12 | 2014 | 1 | 101 | 211 | | A100 | 80 | 100 | D1 | X | ABC |
| 12 | 2014 | 1 | 101 | 212 | | A100 | 20 | 100 | D2 | X | ABC |
| 12 | 2014 | 1 | 101 | 211 | | A110 | 150 | 110 | D1 | X | ABC |
| 12 | 2014 | 1 | 101 | 212 | | A110 | 80 | 110 | D2 | X | ABC |
| 12 | 2014 | 1 | 101 | | 123 | A110 | 20 | 110 | D3 | X | ABC |
| 12 | 2014 | 1 | 101 | 211 | | L200 | −200 | 200 | D1 | X | ABC |
| 12 | 2014 | 1 | 101 | 211 | | E300 | −100 | 300 | D1 | X | ABC |
| 12 | 2014 | 1 | 101 | 211 | | E310 | −30 | 310 | D1 | X | ABC |
| 12 | 2014 | 1 | 101 | 212 | | R400 | −20 | 310 | D2 | X | ABC |
| 12 | 2014 | 2 | 102 | 221 | | 1 | 160 | 100 | D1 | Y | ABC |
| 12 | 2014 | 2 | 102 | 222 | | 1 | 40 | 100 | D2 | Y | ABC |
| 12 | 2014 | 2 | 102 | 221 | | 2 | 300 | 110 | D1 | Y | ABC |
| 12 | 2014 | 2 | 102 | 222 | | 2 | 160 | 110 | D2 | Y | ABC |
| 12 | 2014 | 2 | 102 | | 124 | 2 | 40 | 110 | D3 | Y | ABC |
| 12 | 2014 | 2 | 102 | 221 | | 3 | −400 | 200 | D1 | Y | ABC |
| 12 | 2014 | 2 | 102 | 221 | | 4 | −200 | 300 | D1 | Y | ABC |
| 12 | 2014 | 2 | 102 | 221 | | 5 | −60 | 310 | D1 | Y | ABC |
| 12 | 2014 | 2 | 102 | 222 | | 6 | −40 | 310 | D2 | Y | ABC |
| 12 | 2014 | 3 | 103 | 231 | | 100 | 120 | 100 | D1 | Z | 123 |
| 12 | 2014 | 3 | 103 | 232 | | 100 | 30 | 100 | D2 | Z | 123 |
| 12 | 2014 | 3 | 103 | 231 | | 110 | 225 | 110 | D1 | Z | 123 |
| 12 | 2014 | 3 | 103 | 232 | | 110 | 120 | 110 | D2 | Z | 123 |
| 12 | 2014 | 3 | 103 | | 125 | 110 | 30 | 110 | D3 | Z | 123 |
| 12 | 2014 | 3 | 103 | 231 | | 200 | −300 | 200 | D1 | Z | 123 |
| 12 | 2014 | 3 | 103 | 231 | | 300 | −150 | 300 | D1 | Z | 123 |
| 12 | 2014 | 3 | 103 | 231 | | 310 | −45 | 310 | D1 | Z | 123 |
| 12 | 2014 | 3 | 103 | 232 | | 310 | −30 | 310 | D2 | Z | 123 |

The effect of the second stage mapping can be seen by the mapping of the particular system Account Number (S.Acc in Table D) to the master Account Number (M.Acc in Table D). Also the addition of supplemental data is shown by the inclusion of Country in the Table D.

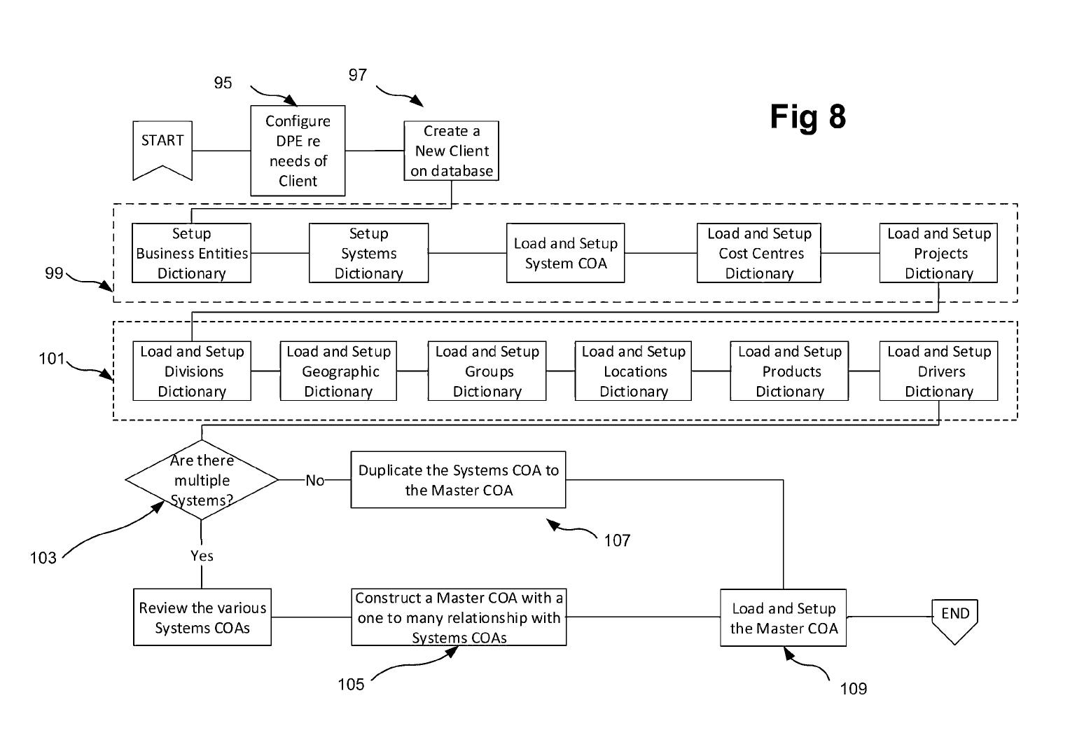

As can be appreciated, the input end of the data processing system 11 needs to be customised for each client that uses it. This is done logically by means of a configuration process shown generally in FIG. 8. An administrative user setting up the data processing system 11 at the outset is required to have regard to the existing business reporting requirements of the client across the full extent of the organization. Once these are established, the data processing engine 7 can be initially configured at 95 to import the source data from the financial and non-financial systems 17 of the client after the client has been created in the database system at 97 and used by the data processing engine.

The administrative user then steps through a series of processes as shown to set up the dictionaries constituting the primary dictionary of the data processing systems at 99 to create the first database structure 31 for the client.

After creating the primary dictionary, the administrative user then steps through a series of processes as shown to set up the dictionaries constituting the secondary dictionary at 101 to create the second database structure 39.

Once the data dictionaries are configured, then the administrative user addresses whether the client has multiple Systems at 103, constructs a master Chart of Accounts at 105 with a one to many relationship with the various systems' Charts of Account if so, or if not, duplicates the system's Chart of Accounts to be the master Chart of Accounts at 107. Finally, the administrative user loads and sets up the master Chart of Accounts at 109 on the second database structure 39.

The software implementation of the processes performed by the data processing engine 7 are more particularly described in the following pseudo code.

Data Input Means 14:
R=RawData(Month, Year, Entity, System, Centre, Project, Account, Amount)

First Stage Mapping Means 15:
Q=(R)×Dictionary(Month, Year, Entity, System, Centre, Project, Account, Amount)

Second Stage Mapping Means 16:
P=(Q)×Dictionary(COAs(Q), Groups(Q), Divisions(Q), Geographic(Q), Departments(q), Locations(Q), Products(Q))

INTEGRITY Checking Process 32:
Check if exists Dictionary(Entity(R), System(R), Centre(R), Project(R), Account(R))
Check Sum of Amount(R)=0

Further Integrity Checking Process 44:
Check if exist Dictionary(COAs(Q), Groups(Q), Divisions(Q), Geographic(Q), Departments(Q), Locations(Q), Products(Q))
Check Sum of Amount(Q)=0

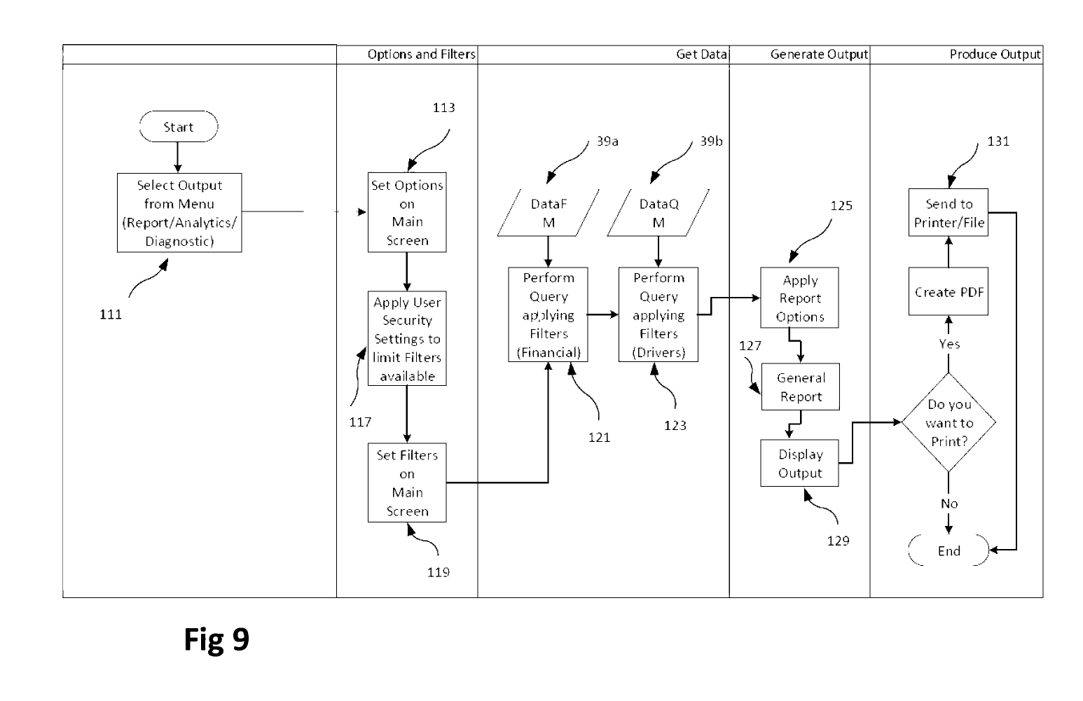

Now having regard to the configuration and operation of the output end, as shown in FIG. 9, the client user selects the output option at 111 from the main menu of the user interface, which allows for analytics, diagnostics and reporting functions to be undertaken by a client user using a main screen 113, including the interactive dashboard interface 47 shown in FIG. 10. This main screen 113 provides the main user interface from which appropriate options and filters derived from the configuration of the client can be accessed and includes a Favourites option (not shown) for predefined report settings of the options and filters available to a user.

As shown in the Options and Filters column in FIG. 9, the options applicable to the particular client are set at 113. These options include: Currency, Year, Month, Consolidate, Compare, Budget, Forecast, Rounding for financial data, Decimal notation for financial data, Rounding for non-financial driver data, Decimal notation for non-financial driver data, Zero Balances and Quarantined Data. These are set out in the top half 115a of a ribbon display 115 of the interactive dashboard interface 47 shown in FIG. 10. Particular clients will require some or all of these options, whereby those options that are not applicable for a particular client user are not displayed, thus restricting client users to seeing what they are authorised to see.

The advanced client user, with appropriate privilege levels, is able to access and preset the role based security settings of all of the authorised users of the client at 117 to limit the filters that are available to them. In the present embodiment, the filters include: Group type, Group Code, Project Level, Project Code, Division Level, Division Code, Manager, Sponsor, Geographical Level, Geographical Level, Geographical Code, Driver Level, Driver Category, Entity, Department, Location Code, and Cost Centre. These are set out in the bottom half of the ribbon display 115 shown in FIG. 10. As in the case of Options setting, particular clients will require some or all of these filters to be set which is attended to at 119, as will different authorised users within or associated with the client, whereby those filters that are not applicable for a particular client or user are not displayed, again restricting users to seeing only what they are authorised to see.

Once the options and filters are set, the system is available for use by an authorised client user to perform analysis, diagnostics and/or reporting. An authorised client user would then access the system by selecting the output option at 111 and then proceed through setting options at 113 and filters at 119 that have been set to be available to him or her. The preset security settings process 117 restricts what filters are available to the client user.

Once the appropriate selections are made by the authorised user, which determine whether analytics, diagnosis or reporting functions are undertaken, the analytics and diagnosis engine presents the selections in the form of a first query at 121 applying the selected financial filters addressing the financial management data table 39a for the financial data values, and then in the form of a second query at 123 applying the selected driver filters addressing the quantitative management data table 39b for the non-financial data values.

The results are then output in the next column by a process applying the selected report options at 125 to the extracted data values and then formatting the data values in a general report at 127, which is compiled in a file for display output at 129.

The final column at 131 shows a process that provides options for producing the final output in a PDF file and printing or not.

In this manner, the client user is able to ‘slice and dice’ information in the second database structure to the extent that they are authorised to do so by virtue of the options and filters settings that they are restricted to accessing and reporting formats which have been customised for the particular client and become the client's standardised format. Prior art analytics, diagnostics and reporting systems generally require technical skill by the end user to know commands and have intimate knowledge of the system to access information.

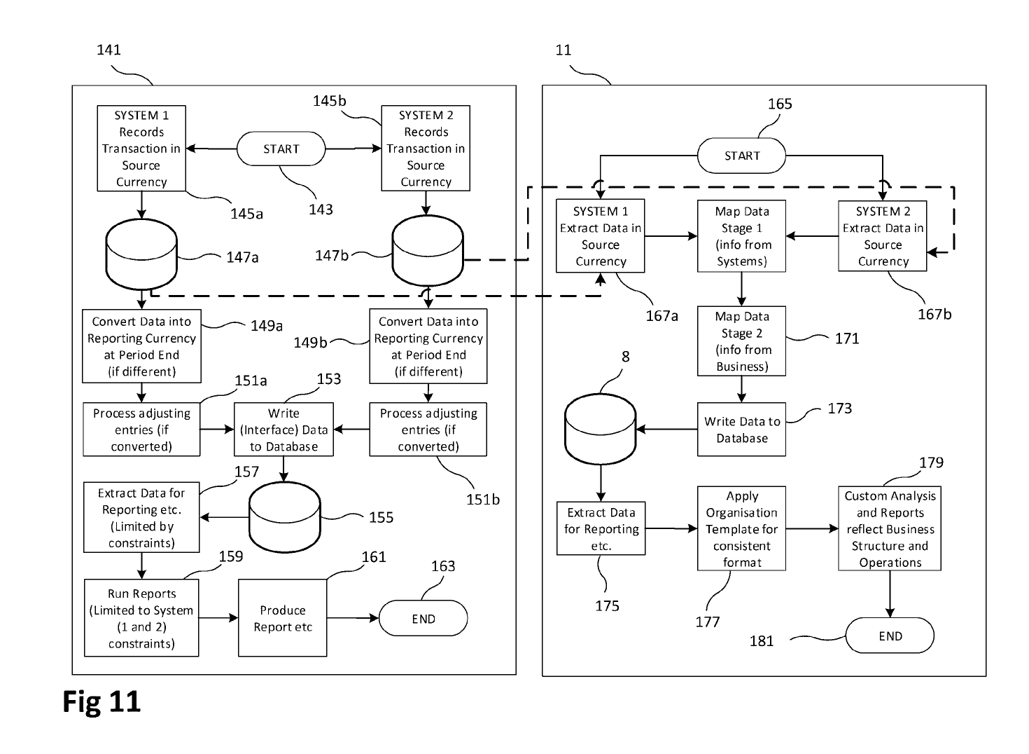

Now describing how the data processing system 11 of the present embodiment interconnects with a traditional prior art transactional processing systems, reference is made to FIG. 11 of the drawings, which also demonstrates the different processing methodology of both systems to produce a specified Output.

As shown in FIG. 11, a pre-existing transactional processing system 141 starts at 143 with recording transactions of an organization's financial and non-financial data of its separate business units having different source currencies using their corresponding transactional systems 145a and 145b. The financial and non-financial data is stored as big data within the respective data stores 147a and 147b associated with the particular transactional system 145 of the organization. This big data constitutes the discrete source data 28 of the organization. As shown, the data processing system 11 of the present embodiment uses this same source data 28 for the inputting of raw data into the data processing engine 7.

In order to achieve a specified Output, the pre-existing transactional processing system 141 separately converts the source data 28 stored within each separate data store 147 for each system into the required reporting currency at Period End, if different, at 149a and 149b respectively. It then separately processes adjusting entries, if converted, at 151a and 151b, respectively, and rights the data to a database in the reporting currency via an interface at 153 which is stored in a further data store 155. Data is then extracted at 157 in the reporting currency for reporting, analytics and diagnostics, modified as 159 a different financial years, if required before producing the specified Output at 161 to end the process at 163.

In contrast, the data processing system 11 of the present embodiment starts at 165 and extracts raw data from the respective data stores 147a and 147b of the different transactional systems 145a and 145b in the source currency using the data input means 14 of the data processing engine 7. This data is then mapped at 169 using the first stage mapping means 15 creating the first structured data set of mapped data; and then it is subsequently mapped at 171 using the second stage mapping means creating the second structured data set of mapped data. This data is then written to the second database structure 39 in the source currency to form the data pool, which is stored in the data store 8. It is from this data pool that data can be extracted from the data store 8 in runtime mode 175, modified and calculated to appear as specified Output, converting the data into the reporting currency, calculating adjusting values for foreign exchange conversion and multiple financial years before formatting the data to finally produce the specified Output to end the process.

It should be appreciated that the scope of the present invention is not limited to the specific embodiment described as the best mode for carrying out the invention. Changes and modifications to the processes described that achieve the same outcome of the present invention are envisaged to form part of the invention and do not detract from it.

1. A data processing system for generating a related set of discrete data sourced from a plurality of financial or non-financial systems of an organization, or a combination of both, each compiled to comply with the same or a different set of business requirements or practices to the other, the system including:
data input means to receive raw data in relation to various business units of the organization sourced from the financial or non-financial systems of the organization;
first stage mapping means to map the raw data into a first database structure using a primary data dictionary detailing the mapped data according to prescribed parameters characterizing the organization and its business units in terms of its operational requirements as determined by the financial or non-financial systems; and
second stage mapping means to further map the first stage mapped data in the first database structure into a second database structure using a secondary data dictionary detailing the second stage mapped data according to prescribed groups characterizing the organization in terms of its management specification as determined by a preset of the management requirements of the organization, whereby the management specification can be derived from the first stage mapped data;
wherein the management requirements of the organization are ascertained in accordance with the information required to manage different parts or aspects of the organization, the information being independent of, but overlapping with, the specification of the operational requirements of the organization.

2. The data processing system as claimed in claim 1, wherein the prescribed parameters include Systems, Chart of Accounts, Business Entities, Cost/Profit/Investment centres, Projects/Jobs and Drivers of the business.

3. The data processing system as claimed in claim 1, wherein the first stage mapping means includes an integrity checking process to check the integrity of the first stage mapped data derivable from the financial systems having regard to prescribed accounting requirements and reject the data if it is not verified.

4. The data processing system as claimed in claim 3, wherein the integrity of the first stage mapped data is checked using the Trial Balance based on the Chart of Accounts of the financial system and is verified when the sum of the Trial Balance equals zero (debits equal credits).

5. The data processing system as claimed in claim 1, wherein the prescribed groups include economic and reporting Groups, Divisions within all of the groups, Geographic constraints and boundaries for reporting purposes, Business Entities, Cost/Profit/Investment centres within all of the Groups, Project Numbers within all of the Groups, Account Numbers for Charts of Account and Account Balances.

6. The data processing system as claimed in claim 1, wherein the first stage mapping means includes an integrity checking process to check the integrity of the first stage mapped data having regard to prescribed accounting requirements and reject the data if it is not verified.

7. The data processing system as claimed in claim 1, wherein the second stage mapping means includes a further integrity checking process to check the integrity of the second stage mapped data, firstly having regard to its existence in the prescribed groups and providing a warning to allow for rectification of any problem identified if it does not exist, and secondly after the first check is successful, quarantining the second stage mapped data for limited access until verified as accurate and thereafter opening access to the second stage mapped data to permit reporting and analysis thereof.

8. The data processing system as claimed in claim 1, including an analytics and reporting engine to select options and filters to apply to the second stage mapped data from the second database structure and select and extract filtered data according to the applied options and filters to perform analytic and diagnostic functions, and output the filtered data in the form of a customised report.

9. The data processing system as claimed in claim 8, wherein the analytics and reporting engine includes a filtering process to apply selected filters to selected groups of the second stage mapped data from the second database structure and produce a subset of structured data for subsequent analysis and diagnostic purposes.

10. The data processing system as claimed in claim 8, wherein the analytics and reporting engine includes analyses processes to perform analytics and diagnostics on the subset of structured data, such as Ratio Analysis, Trend Analysis, Z-Scores, Diagnostic Flow Chart of the Business, Business Valuations and risk or other proprietary analysis.

11. The data processing system as claimed in claim 8, wherein the analytics and reporting engine includes an integrity checking process to check the integrity of the selected data back to the source data.

12. The data processing system as claimed in claim 8, wherein the analytics and reporting engine includes a further integrity checking process to check the integrity of any report created by checking that the reported information balances to the source data.

13. The data processing system as claimed in claim 1, wherein the data input means also receives supplemental data from an alternative source to be mapped by the first stage mapping means along with the received raw data, the supplemental data representing innate characteristics of the organization that are not directly derivable from the raw data.

14. A method for generating a related set of discrete data sourced from a plurality of financial or non-financial systems of an organization, or a combination of both, each compiled to comply with the same or a different set of business requirements or practices to the other, the system including:
receiving raw data in relation to various business units of the organization sourced from the financial or non-financial systems of the organization;
mapping the raw data into a first database structure using a primary data dictionary detailing the mapped data according to prescribed parameters
characterizing the organization and its business units in terms of its operational requirements as determined by the financial or non-financial systems; and
further mapping the first stage mapped data in the first database structure into a second database structure using a secondary data dictionary detailing the second stage mapped data according to prescribed groups characterizing the organization in terms of its management specification as determined by a preset of management requirements of the organization, whereby the management specification can be derived from the first stage mapped data;
wherein the management requirements of the organization are ascertained in accordance with the information required to manage different parts or aspects of the organization, the information being independent of, but overlapping with, the operational requirements of the organization.

15. The method as claimed in claim 14, wherein the prescribed parameters include Systems, Chart of Accounts, Business Entities, Cost/Profit/Investment centres, Projects/Jobs and Drivers of the business.

16. The method as claimed in claim 14, including checking the integrity of the first stage mapped data derivable from the financial systems having regard to prescribed accounting requirements and rejecting the data if it is not verified.

17. The method as claimed in claim 16, wherein the integrity of the first stage mapped data is checked using the trial balance based on the chart of accounts of the financial system and is verified when the sum of the trial balance equals zero (debits equal credits).

18. The method as claimed in claim 14, wherein the prescribed groups include economic and reporting Groups, Divisions within all of the Groups, Geographic constraints and boundaries for reporting purposes, Business Entities, Cost/Profit/Investment centres within all of the Groups, Project Numbers within all of the Groups, Account Numbers for Charts of Account and Account Balances.

19. The method as claimed in claim 14, including checking the integrity of the first stage mapped data having regard to prescribed accounting requirements.

20. The method as claimed in claim 14, including checking the second stage mapped data, firstly having regard to its existence in the prescribed groups and providing a warning to allow for rectification of any problem identified if it does not exist, and secondly after the first check is successful, quarantining the second stage mapped data for limited access until verified as accurate and thereafter opening access to the second stage mapped data to permit reporting and analysis thereof.

21. The method as claimed in claim 14, including selecting options and filters to apply to the second stage mapped data and selecting and extracting filtered data according to the applied options and filters to produce a subset of structured data for performing analytic and diagnostic functions thereon.

22. The method as claimed in claim 14, including performing analytics and diagnostics on the subset of structured data, such as Ratio Analysis, Trend Analysis, Z-Scores, Diagnostic Flow Chart of the Business, Business Valuations, and risk and other proprietary analysis.

23. The method as claimed in claim 14, including checking the integrity of the selected data for reporting purposes back to the source data and reject the data if it is not verified.

24. The method as claimed in claim 14, including checking the integrity of any report created by checking that the reported information balances to the source data.

25. The method as claimed in claim 14, including receiving supplemental data from an alternative source to be mapped along with the received raw data, the supplemental data representing innate characteristics of the organization that are not directly derivable from the raw data.
